(19) United States
(12) Patent Application Publication
(10) Pub. No.: US 2015/0198082 A1
(43) Pub. Date: Jul. 16, 2015

(54) Turbocharged Internal Combustion Engine With Pre-Charge Air Cooler

(71) Applicant: GM Global Technologies Operations LLC, Detroit, MI (US)

(72) Inventor: Brian C. PUGH, Grand Blanc, MI (US)

(73) Assignee: GM Global Technologies Operations LLC, Detroit, MI (US)

(21) Appl. No.: 14/157,049

(22) Filed: Jan. 16, 2014

(51) Int. Cl. F02B 29/04

(52) U.S. Cl. CPC F02B 29/0462

(57) ABSTRACT

An internal combustion engine is provided including an engine block defining a plurality of cylinders. A cylinder head is attached to the engine block and includes a plurality of intake ports and a plurality of exhaust ports in communication with the plurality of cylinders. An intake manifold is in communication with the plurality of intake ports and an exhaust passages connect to the plurality of exhaust ports. A turbocharger is in communication with the exhaust passage and has an impeller driven by exhaust gasses from the exhaust passage. The turbocharger includes a compressor for supplying compressed air to the throttle body. A water-to-air pre-charge air cooler is disposed in a flow passage between an outlet of the compressor and the throttle body.

### FIELD

The present disclosure relates to turbocharged internal combustion engines, and more particularly to a turbocharged internal combustion engine with charge air cooling.

### BACKGROUND

This section provides background information related to the present disclosure which is not necessarily prior art.

Turbocharged internal combustion engines utilize a turbocharger that is bolted to the exhaust manifold of the engine. The exhaust from the cylinders spins the turbine, which works like a gas turbine engine. The turbine is connected by a shaft to a compressor, which is located between the air filter and the intake manifold. The compressor pressurizes the air going into the cylinders. The exhaust from the cylinders passes through the turbine blades, causing the turbine to spin. The more exhaust that goes through the blades, the faster they spin. On the other end of the shaft that the turbine is attached to, the compressor pumps air into the cylinders. The compressor draws air in at the center of its blades and flings it outward as it spins. The compressed air from the turbocharger can become heated by the compressor and the heated air can be detrimental to the throttle body.

### SUMMARY

This section provides a general summary of the disclosure, and is not a comprehensive disclosure of its full scope or all of its features.

A water-to-air pre-charge air cooler is provided for cooling the charge air from a turbocharger prior to the throttle body. In particular, an internal combustion engine is provided including an engine block defining a plurality of cylinders. A cylinder head is attached to the engine block and includes a plurality of intake ports and a plurality of exhaust ports in communication with the plurality of cylinders. An intake manifold is in communication with the plurality of intake ports and an exhaust passages connect to the plurality of exhaust ports. A turbocharger is in communication with the exhaust passage and has an impeller driven by exhaust gasses from the exhaust passage. The turbocharger includes a compressor for supplying compressed air to the throttle body. A water-to-air precharge air cooler is disposed in a flow passage between an outlet of the compressor and the throttle body.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of an internal combustion engine assembly having a pre-charge air cooler and a charge air cooler integrated in the intake manifold;

FIG. 2 is a schematic diagram of a water-to-air charge air cooler according to the principles of the present disclosure; and

FIG. 3 is a schematic diagram of a water-to-air pre-charge air cooler according to the principles of the present disclosure.

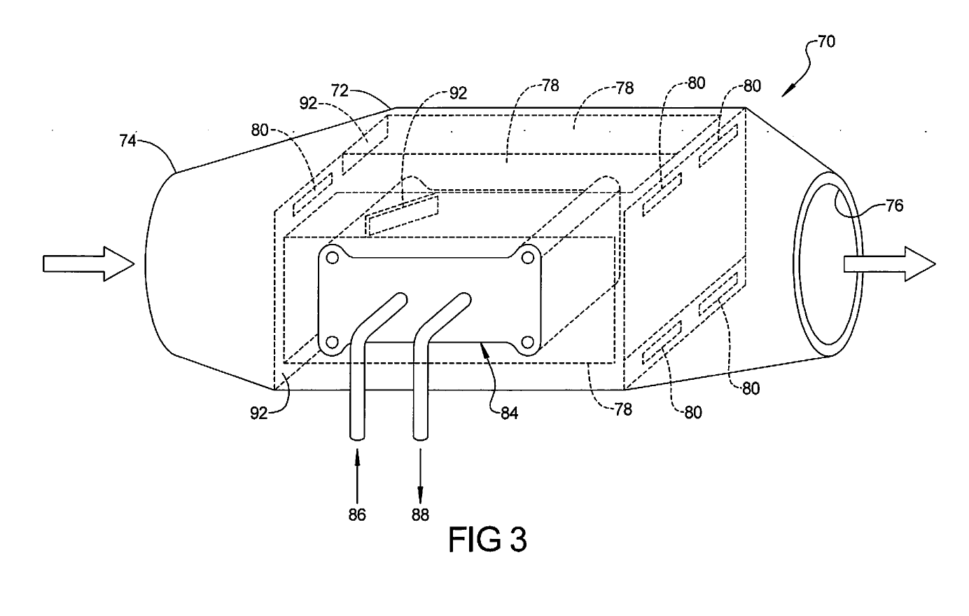

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

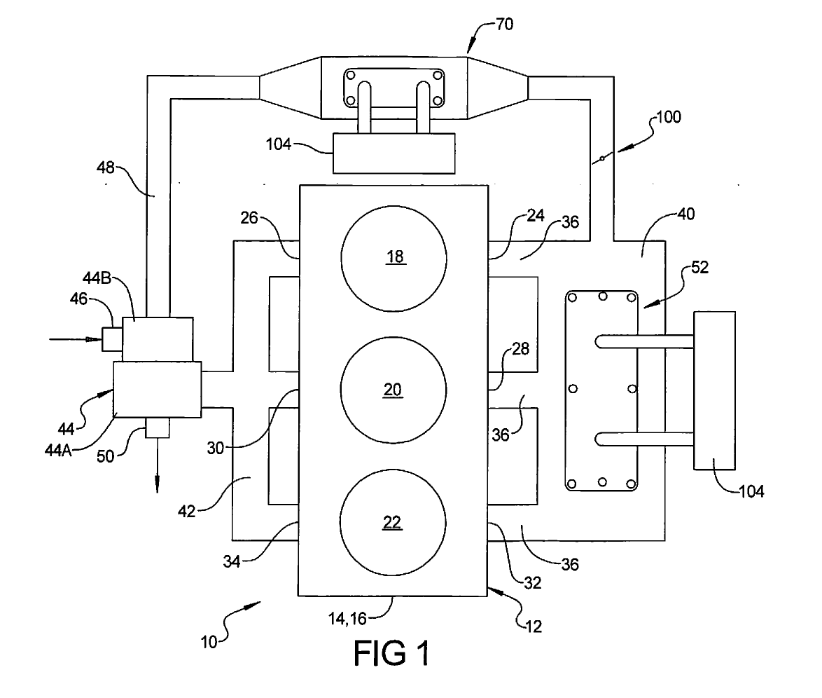

An engine assembly 10 is illustrated in FIG. 1 and includes an engine structure 12. The engine structure 12 may include an engine block 14 and a cylinder head 16. The engine structure 12 may define first, second and third cylinders 18, 20, 22. The description includes first, second and third cylinders 18, 20, 22 for simplicity and it is understood that the present teachings apply to any number of piston-cylinder arrangements and a variety of reciprocating engine configurations including, but not limited to, V-engines, in-line engines, and horizontally opposed engines, as well as both overhead cam and cam-in-block configurations. The engine structure supports a crankshaft and a plurality of pistons that are disposed in the respective cylinders 18, 20, 22, as is known in the art.

The engine structure 12 may define a first intake port 24 and a first exhaust port 26 in the cylinder head 16 associated with the first cylinder 18, a second intake port 28 and a second exhaust port 30 in the cylinder head 16 associated with the second cylinder 20 and a third intake port 32 and a third exhaust port 34 in the cylinder head 16 associated with the third cylinder 22.

Engine assembly 10 includes an intake manifold 40 having a plurality of runners 36 in communication with each of the intake ports 24, 28, 32. An exhaust manifold 42 is in communication with each of the exhaust ports 26, 30, 34. A turbocharger 44 includes a turbine 44A that receives exhaust gases from the exhaust manifold 42 and includes an air intake 46 in communication with a compressor 44B in communication with a charged air passage 48 to the intake manifold 40. The exhaust gasses from the exhaust manifold 42 passed through the turbine 44A of the turbocharger 44 and are exhausted through passage 50. According to the principles of the present disclosure, the intake manifold 40 includes an integrated water-to-air charge air cooler 52. Although the present disclosure is described with a turbocharger 44, the present disclosure applies to boosted engines using turbochargers or superchargers which require cooling of the intake air.

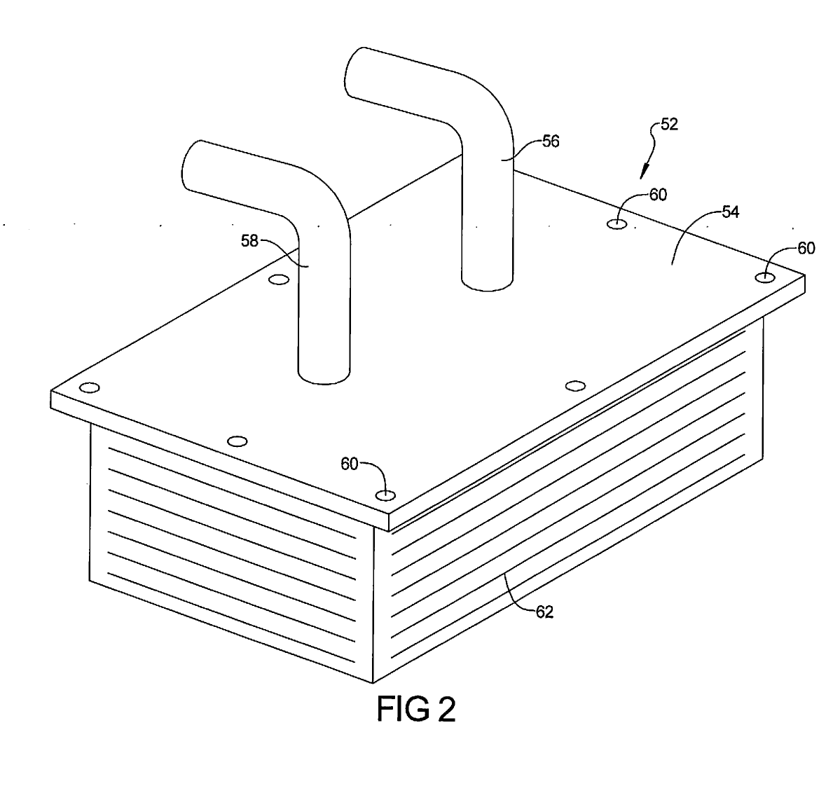

As shown in FIG. 2, the water-to-air charge air cooler 52 can include a mounting plate 54 having an inlet passage 56 and an outlet passage 58 for providing liquid coolant to the charge air cooler 52. The mounting plate 54 can include a plurality of mounting apertures 60 for mounting the mounting plate 54 to the intake manifold 40. The charge air cooler 52 includes a plurality of cooling fins 62 and cooling fluid passages extending therethrough in communication with the coolant inlet 56 and outlet 58. The charged air from the turbocharger 44 passes through the charged air passage 48 into the intake manifold 40 and passes through the charge air cooler 52 prior to entry into each of the intake ports 24, 28, 32. It should be understood that the coolant passages in the charge air cooler can include a plurality of serpentine passages that are interconnected to the cooling fins 62. Similar coolant passages are provided in radiators and other known cooling devices.

In addition to the integrated water-to-air charge air cooler 52, a water-to-air pre-charge air cooler 70 can be provided in the charged air passage 48 upstream of the throttle body 100. The pre-charge air cooler 70 can include a housing 72 having an inlet end 74 and an outlet and 76. The pre-charge air cooler 70 can include a plurality of resonator chambers 78 each provided with a resonator orifice 80. A charge air cooler unit 84 is received within the housing 72 and can include a coolant inlet 86 and a coolant outlet 88. The charge air cooler unit 84 includes a plurality of cooling fins 90 and cooling fluid passages extending therethrough in communication with the coolant inlet 86 and coolant outlet 88. The charge air cooler unit 84 can be constructed in a manner similar to the charge air cooler 52, as discussed above. The resonator chambers 78 can each be provided with dead headed chamber walls 92 that are designed according to the operating characteristics of the internal combustion engine 10 in order to reduce/eliminate vibrations caused by resonant intake air flow.

The coolant inlets 56, 86 and the coolant outlets 58, 88 of the charge air cooler 52 and pre-charge air cooler 70 can be connected to a pump device 104 which can be utilized as a single pumping device or as separate pumping devices.

The pre-charge air cooler according to the principles of the present disclosure provides the option to use current technology throttle body and shell welded composite air intake manifolds due to the reduced temperature achieved by the pre-charge air cooler. The pre--charge air cooler can be plumbed into a high temperature circuit to also provide the ability to use the pre-charge air cooler as a cold start air Inlet heater device.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An internal combustion engine, comprising:
an engine block defining a plurality of cylinders;
a cylinder head attached to the engine block and including a plurality of intake ports and a plurality of exhaust ports in communication with the plurality of cylinders;
an intake manifold in communication with the plurality of intake ports, wherein the intake manifold includes an integrated water-to-air charge air cooler;
a throttle body disposed upstream of the intake manifold;
an exhaust passage connected to the plurality of exhaust ports;
an turbocharger in communication with the exhaust passage and having an impeller driven by exhaust gases from the exhaust passage, the turbocharger including a compressor for supplying compressed air to the throttle body; and
a water-to-air pre-charge air cooler disposed between an outlet of the compressor and the throttle body.

2. The internal combustion engine according to claim 1, wherein the pre-charge air cooler is integrated with at least one resonator chamber.

3. (canceled)

4. An internal combustion engine, comprising:
an engine block defining a plurality of cylinders;
a cylinder head attached to the engine block and including a plurality of intake ports and a plurality of exhaust ports in communication with the plurality of cylinders;
an intake manifold in communication with the plurality of intake ports, wherein the intake manifold includes an integrated water-to-air charge air cooler;
a throttle body disposed upstream of the intake manifold;
an exhaust passage connected to the plurality of exhaust ports;
an intake air booster system including a compressor for supplying compressed air to the throttle body; and
a water-to-air pre-charge air cooler disposed between an outlet of the compressor and the throttle body.

5. The internal combustion engine according to claim 4, wherein the pre-charge air cooler is integrated with at least one resonator chamber.

6. (canceled)

7. The internal combustion engine according to claim 4, wherein the intake air booster system includes a turbocharger.

8. (canceled)
